(19) United States
(12) Patent Application Publication
(10) Pub. No.: US 2025/0292324 A1
(43) Pub. Date: Sep. 18, 2025

(54) System and Method for Cross-Ecosystem Financial Reputation Scoring and Blockchain- Integrated Transactions

(71) Applicant: Danielle Murray, Pleasantville, NY (US)

(72) Inventor: Danielle Murray, Pleasantville, NY (US)

(21) Appl. No.: 19/051,177

(22) Filed: Feb. 12, 2025

(51) Int. Cl. G06Q 40/03; H04L 9/08

(52) U.S. Cl. CPC G06Q 40/03; H04L 9/0852; G06Q 2220/00

(57) ABSTRACT

The present invention discloses a blockchain-integrated financial reputation scoring system designed to assess financial credibility within decentralized ecosystems. The system generates a dynamic accountability score based on blockchain transactions, including escrow payments, invoice completions, smart contract interactions, DeFi transactions, NFT trading, and cross-chain financial activities. A risk-adaptive score weighting system dynamically adjusts the impact of financial behaviors based on transaction risk, counterparty trustworthiness, and historical financial patterns. The score is leveraged for tiered access to financial products, lending, and collateral adjustments. AI-enhanced anomaly detection prevents fraudulent score inflation, while privacy-preserving verification ensures secure reputation authentication. The system further extends into insurance underwriting, compliance verification (AML/KYC), and financial access expansion, allowing traditional institutions to assess blockchain-based creditworthiness. Quantum-resistant cryptographic techniques secure reputation data, ensuring trust and adaptability in both decentralized and traditional financial ecosystems.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED VIA THE PATENT ELECTRONIC SYSTEM

Not Applicable

### SEQUENCE LISTING

Not Applicable

### FIELD OF THE INVENTION

The present invention relates to a blockchain-integrated financial reputation system that evaluates and updates financial credibility within decentralized financial ecosystems.

The system dynamically calculates, adjusts, and applies an accountability score based on financial behaviors recorded on at least one Web3 blockchain network.

The invention enables risk-based financial decision-making, ensuring lenders, insurers, and other decentralized financial institutions can assess trustworthiness based on real-time, adaptive, and blockchain-validated reputation scoring.

The system is designed to provide tiered financial access, including risk-based loans, collateralized borrowing, staking eligibility, and governance participation.

Additionally, it enhances financial reputation portability across blockchain ecosystems and ensures security through quantum-resistant cryptographic techniques.

A financial access expansion module allows traditional financial institutions, including banks and credit bureaus, to assess blockchain-based financial reputation as part of lending and credit evaluations.

### BACKGROUND OF THE INVENTION

Existing financial reputation models, including traditional credit scores and Web3 reputation protocols, have several limitations.

Traditional financial systems and blockchain reputation models do not dynamically adjust scores based on evolving financial risks or market conditions.

Existing reputation models focus on Web2 credit data or isolated blockchain interactions, failing to synchronize financial reputation across multiple blockchain networks.

A reputation score earned on one blockchain is often not transferable to other blockchain ecosystems, requiring users to rebuild trust on different platforms.

Traditional credit and reputation scores can be artificially inflated through repetitive low-risk transactions or other exploitative behaviors.

Most current financial reputation systems lack privacy-preserving mechanisms that allow users to verify their reputation without exposing sensitive financial data.

This invention resolves these issues by introducing a real-time, adaptive, multi-chain financial reputation scoring system that dynamically updates accountability scores based on financial behaviors, transaction risks, and market conditions.

It enables cross-chain reputation portability, ensuring credibility remains valid across multiple blockchain ecosystems.

The system prevents score inflation and fraudulent reputation-building through AI-powered anomaly detection and reputation decay mechanisms.

Additionally, privacy-preserving financial reputation verification is supported via zero-knowledge proofs and verifiable credentials.

The reputation data is secured using quantum-resistant cryptographic techniques to protect against emerging cryptographic threats.

### BRIEF SUMMARY OF THE INVENTION

The present invention introduces a modular blockchain-integrated financial reputation scoring system designed to assess financial credibility across decentralized and traditional ecosystems.

The system comprises independently configurable modules, allowing the components involved in generating, adjusting, or verifying a user's accountability score to be tailored or extended based on evolving financial contexts, regulatory requirements, or institutional risk preferences.

It includes a dynamic accountability score that updates in real time based on financial behaviors recorded on at least one Web3 blockchain network, including escrow completions, DeFi activity, NFT transactions, and smart contract interactions.

A risk-adaptive score weighting system dynamically adjusts the impact of financial behaviors based on transaction risk, counterparty trustworthiness, and historical behavior patterns.

The system supports tiered financial access, allowing users to qualify for financial services such as lending, collateral adjustments, staking eligibility, or governance participation based on their reputation.

AI-enhanced anomaly detection prevents score inflation and fraudulent behavior patterns by identifying manipulation tactics or suspicious asset flows.

A privacy-preserving verification layer enables users to prove their accountability score to third parties without exposing raw transaction data, using zero-knowledge proofs and verifiable credentials.

The system facilitates real-world integration by enabling banks, credit bureaus, and insurance companies to assess blockchain-based reputations for underwriting, compliance, and financial access decisions.

It also incorporates cross-chain synchronization, allowing financial reputation to persist across multiple blockchain ecosystems without redundant trust-building.

A reputation decay mechanism ensures scores remain accurate over time, particularly in the absence of ongoing activity.

Furthermore, the system tracks ESG-aligned behaviors and metaverse-based financial participation, extending the reputation score into digital and socially responsible domains.

Quantum-resistant cryptographic protections secure all reputation-related data and interactions, ensuring resilience against future cryptographic threats and ensuring long-term trust.

### BRIEF DESCRIPTION OF THE DRAWINGS

FIG. 1A illustrates the user types and platform interactions in the cross-ecosystem financial reputation system, including interactions between contractors, freelancers, businesses, and Web2/Web3 platforms.

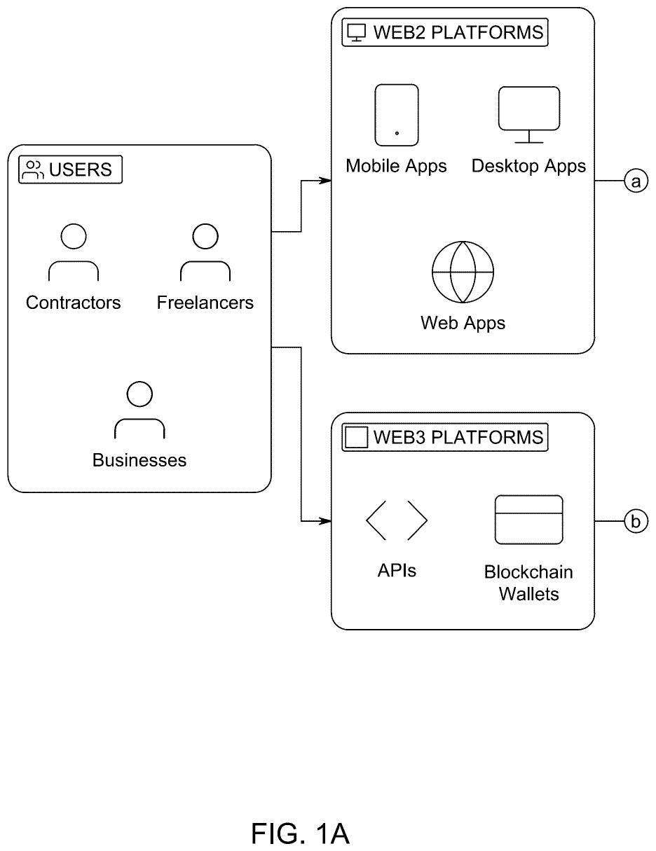

FIG. 1B illustrates the internal architecture of the system, including the data processing module, AI risk analysis, scoring engine, regulatory compliance, and sources of Web2/Web3 financial data.

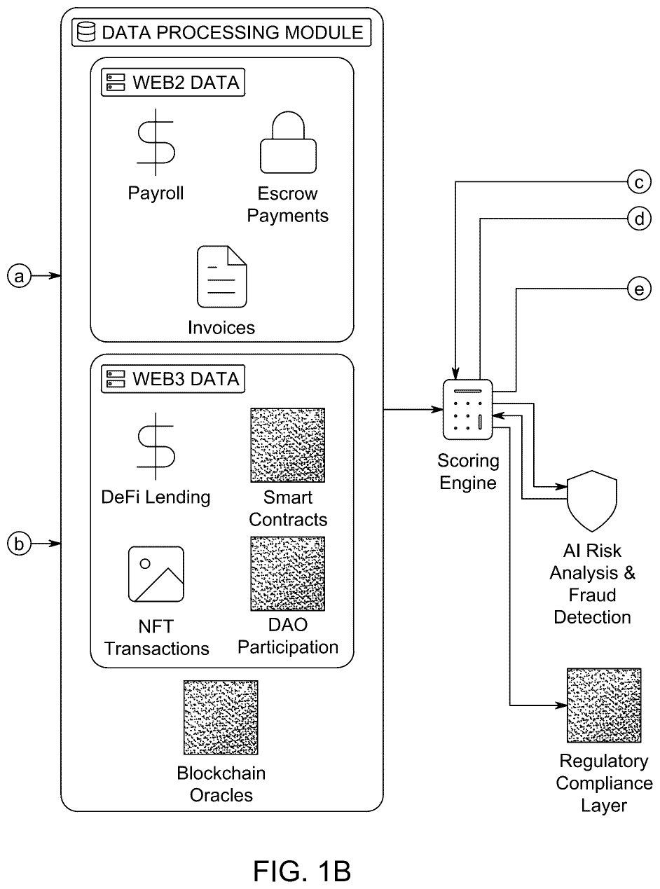

FIG. 1C illustrates the decentralized identity representations and financial access module, detailing how reputation scores interface with both Web2 and Web3 financial systems.

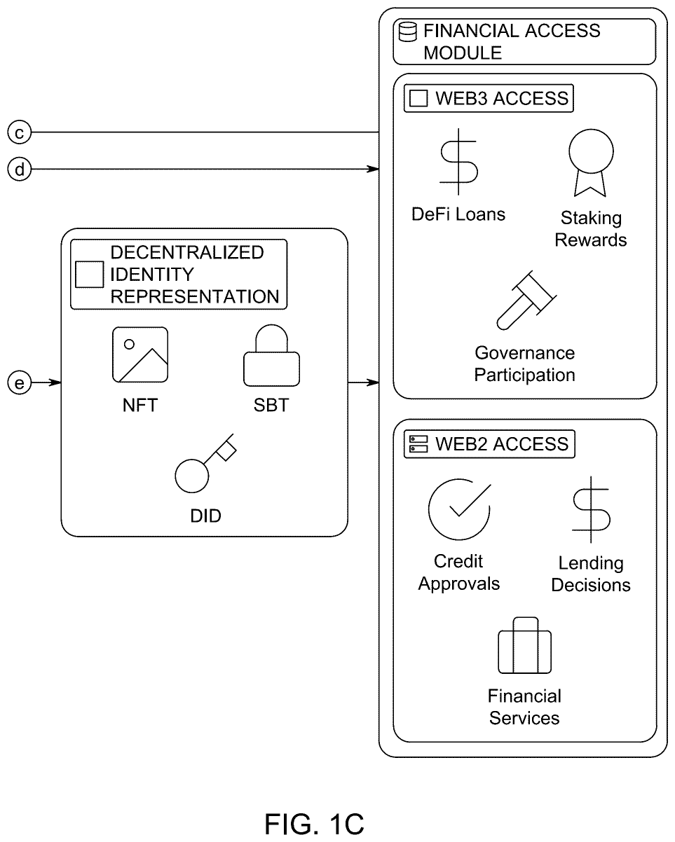

### DETAILED DESCRIPTION OF THE INVENTION

The invention consists of a modular reputation scoring engine that integrates with Web3 financial platforms.

The system includes a data processing module that tracks and analyzes blockchain financial transactions, including escrow payments, smart contract interactions, DeFi transactions, and NFT trading.

The scoring engine calculates and updates a real-time accountability score based on financial behaviors, counterparty trustworthiness, and risk conditions.

A financial access module enables users to leverage their reputation score for loans, collateral, staking, and governance participation.

A risk-adaptive score weighting system dynamically adjusts the impact of financial behaviors on reputation scores based on real-time risk factors and transaction credibility.

Cross-chain reputation synchronization ensures that a user's financial reputation remains valid across multiple blockchains, preventing the need to rebuild financial trust.

The system incorporates AI-enhanced anomaly detection that uses pattern recognition and transaction monitoring to flag fraudulent activities, reputation manipulation attempts, and score inflation strategies.

A reputation decay mechanism ensures long-term score accuracy by lowering scores over time in the absence of financial activity.

A privacy-preserving verification system employs zero-knowledge proofs and verifiable credentials to enable users to prove their financial reputation without revealing raw transaction history.

The accountability score integrates with decentralized identity frameworks including NFTs, SBTs, and DIDs.

Additionally, an insurance and compliance module assesses financial risk, fraud patterns, and identity verification for underwriting insurance policies and regulatory compliance (KYC/AML).

Machine learning algorithms further enhance the system's capacity to predict credit risks and financial behaviors.

The invention supports ESG-based reputation metrics and metaverse integration, tracking sustainable investments and digital asset histories.

A staking-based mechanism allows users to stake assets to demonstrate economic trust and enhance their score.

An AI agent module assists users in executing financial actions, influencing their accountability score in real-time.

The system enables users to lock reputation scores for trust guarantees, and use them as algorithmic credit collateral.

A quantum-resistant security layer secures all reputation-related cryptographic transactions using post-quantum cryptographic methods.

### Advantages of the Invention

The invention is modular by design, enabling its components-such as the data processing module, risk-adaptive weighting engine, or scoring factors-to be customized or extended to meet evolving use cases or regulatory requirements. This flexibility allows institutions to fine-tune the scoring logic based on market conditions, policy changes, or novel financial instruments.

It prevents fraud and score manipulation through AI anomaly detection while ensuring Web3 reputation remains portable across multiple blockchains.

The system bridges Web3 financial reputation with traditional credit models, providing quantum-resistant security to ensure long-term cryptographic safety.

The invention facilitates privacy-preserving verification, making financial reputation assessment secure and decentralized.

Additionally, it expands into metaverse and digital economies, ensuring financial reputation extends beyond traditional finance.

### Conclusion

This invention introduces a next-generation financial reputation system that is cross-chain, adaptive, privacy-preserving, and secure against quantum threats.

It enables Web3 lenders, banks, insurers, and metaverse economies to assess financial credibility in real time, ensuring a scalable, decentralized, and secure financial trust model for the future.

1. A system for cross-ecosystem financial reputation scoring, comprising:
A data processing module configured to track and analyze blockchain financial transactions, including but not limited to escrow payments, invoice completion rates, smart contract interactions, decentralized finance (DeFi) transactions, non-fungible token (NFT) trading, and cross-chain financial activities;
A scoring engine configured to calculate a dynamic accountability score based on financial behaviors recorded on at least one Web3 blockchain network;
A real-time reputation updating mechanism, wherein the accountability score dynamically adjusts based on recorded and validated financial behaviors;
A risk-adaptive score weighting system, wherein the system dynamically adjusts the impact of financial behaviors on a user's reputation score, including but not limited to transaction risk, counterparty trustworthiness, financial market conditions, and historical financial patterns.

2. The system of claim 1, further comprising a tiered financial access system, wherein a user's eligibility for financial products and benefits dynamically scales based on their accountability score, enabling risk-based loan approvals, collateral adjustments, or exclusive lending opportunities.

3. The system of claim 1, further comprising a cross-chain reputation synchronization module, wherein a user's financial reputation score is portable and recognized across multiple blockchain networks, ensuring continuous credibility.

4. The system of claim 1, further comprising an AI-enhanced anomaly detection module, wherein patterns of suspicious financial behavior, including rapid score manipulation attempts or sudden large asset shifts, are flagged for additional verification.

5. The system of claim 1, further comprising a reputation decay mechanism, wherein scores decrease over time if no active financial behaviors occur, ensuring long-term reputation accuracy.

6. The system of claim 1, wherein the accountability score integrates with decentralized identity frameworks, including but not limited to non-fungible tokens (NFTs), soulbound tokens (SBTs), or decentralized identifiers (DIDs) as cryptographic reputation representations.

7. The system of claim 1, wherein the accountability score dynamically updates based on Web2 financial data, including but not limited to payroll records, traditional loan payments, and escrow completion records.

8. The system of claim 1, further comprising a financial access expansion module, wherein the accountability score is leveraged for loans, collateral, and financial services within traditional financial institutions, including but not limited to banks, credit bureaus, and regulated lending platforms.

9. The system of claim 1, wherein the financial access module includes a privacy-preserving reputation disclosure system, wherein users can prove their accountability score to third parties without exposing underlying transaction history using zero-knowledge proofs or verifiable credentials.

10. The system of claim 1, wherein the accountability score is leveraged for loans, collateral, and financial services across decentralized financial institutions.

11. The system of claim 1, further comprising a staking-based reputation enhancement mechanism, wherein users may stake digital assets to improve their financial reputation score, demonstrating economic commitment.

12. The system of claim 1, wherein the accountability score is used to influence non-financial access, including but not limited to governance participation in decentralized autonomous organizations (DAOs) and access to exclusive digital ecosystems.

13. The system of claim 1, wherein the reputation synchronization module further enables cross-platform reputation verification, allowing Web3 reputation data to be validated by Web2 financial institutions.

14. The system of claim 1, wherein the accountability score incorporates ESG (Environmental, Social, and Governance) impact factors, including but not limited to charitable donations, sustainability initiatives, and socially responsible investments.

15. The system of claim 1, wherein users can delegate portions of their accountability score as collateral or trust guarantees for other users in a lending environment.

16. The system of claim 1, wherein accountability scores factor in financial behaviors within metaverse environments, including but not limited to virtual asset purchases, participation in digital economies, and ownership history of metaverse-based assets.

17. The system of claim 1, wherein machine learning algorithms predict credit risks, lending eligibility, financial trustworthiness, and financial access recommendations.

18. The system of claim 1, wherein accountability scores integrate with NFT-based lending markets, allowing users to use verified on-chain reputation as a factor in NFT-backed borrowing and lending agreements.

19. The system of claim 1, wherein accountability scores influence access to tokenized credit markets, wherein users may participate in decentralized credit pools based on verified financial reputation.

20. The system of claim 1, further comprising an insurance underwriting module, wherein users' blockchain-based financial behavior is analyzed to determine eligibility and pricing for decentralized and traditional insurance products.

21. The system of claim 1, wherein an AI-assisted financial reputation analysis module dynamically evaluates a user's accountability score by analyzing, including but not limited to, historical financial behaviors, risk trends, transaction patterns, counterparty trustworthiness, and market conditions.

22. The system of claim 1, wherein users can earn improvements to their accountability score by completing smart contract-based financial milestones, including but not limited to on-time repayment of blockchain-based loans, long-term asset holding behavior, and active participation in financial governance mechanisms.

23. The system of claim 1, wherein accountability scores integrate with compliance verification systems, including but not limited to AML (Anti-Money Laundering) and KYC (Know Your Customer) regulatory frameworks.

24. The system of claim 1, wherein an accountability score-linked payment module enables the issuance and management of blockchain-integrated credit or debit cards.

25. The system of claim 1, wherein an AI agent module facilitates execution of financial actions, wherein the agent's decisions, including but not limited to smart contract interactions, on-chain transactions, credit-based actions, and staking behaviors, influence the user's accountability score.

26. The system of claim 1, wherein a user's financial reputation can be used as collateral for algorithmic credit lines, wherein the system enables users with high accountability scores to obtain under-collateralized credit within Web3 financial ecosystems.

27. The system of claim 1, wherein accountability scores integrate with real-world credit systems, allowing banks and financial institutions to assess blockchain financial history as part of credit decision-making.

28. The system of claim 1, wherein accountability scores are secured using quantum-resistant cryptographic techniques, including but not limited to post-quantum cryptographic hash functions, lattice-based cryptography, and quantum-safe key exchange protocols.

29. The system of claim 1, wherein users may lock portions of their accountability score for predefined periods to enhance financial trustworthiness.

30. The system of claim 1, wherein accountability scores are used to generate risk-adjusted borrowing limits, wherein users with higher accountability scores receive increased loan limits or reduced collateralization requirements within decentralized financial institutions.
